(19) United States
(12) Patent Application Publication
(10) Pub. No.: US 2014/0237208 A1
(43) Pub. Date: Aug. 21, 2014

(54) PROTECTING MEMORY DIAGNOSTICS FROM INTERFERENCE

(71) Applicant: HEWLETT-PACKARD DEVELOPMENT COMPANY, L.P., Houston, TX (US)

(72) Inventor: Mark R. Colbert, Humble, TX (US)

(73) Assignee: Hewlett-Packard Development Company, L.P., Houston, TX (US)

(21) Appl. No.: 13/771,293

(22) Filed: Feb. 20, 2013

(51) Int. Cl. G06F 12/02

(52) U.S. Cl. CPC G06F 12/0284
USPC 711/170

(57) ABSTRACT

Disclosed herein are techniques for managing diagnostics of computer memory. A range of contiguous addresses of a physical memory are associated with or mapped to addresses of a virtual memory. The range of contiguous addresses is protected from interference.

### BACKGROUND

Memory testing may be performed as part of an overall diagnosis of computer hardware problems. During a memory test, physical memory may be allocated and testing algorithms may be performed thereon. A testing algorithm may include rules for writing and reading to and from the allocated memory and rules for detecting memory errors.

### BRIEF DESCRIPTION OF THE DRAWINGS

FIG. 1 is a block diagram of an example system in accordance with aspects of the present disclosure.

FIG. 2 is a flow diagram of an example method in accordance with aspects of the present disclosure.

FIG. 3 is a working example in accordance with aspects of the present disclosure.

FIG. 4 is a further working example in accordance with aspects of the present disclosure.

### DETAILED DESCRIPTION

As noted above, testing algorithms may be performed on physical memory during a memory test. Many operating systems heretofore, such as the Linux operating system, may provide memory to executing programs via a virtual memory system. Such operating systems may associate virtual memory addresses with actual physical memory addresses; if the physical addresses have been exhausted, the virtual memory addresses may be associated with disk space or some other storage medium. As such, a virtual memory system allows executing programs to proceed despite the depletion of physical memory. Memory testing programs may assume that the virtual addresses being referenced during the test are associated with physical memory, even when they are actually mapped to some other storage medium. However, if memory diagnostics execute on disk space or other storage medium rather than physical memory, critical physical memory errors may be overlooked. Unfortunately, memory testing programs may not be able to determine whether the virtual memory is mapped to actual physical memory.

In view of the foregoing, disclosed herein are a system, non-transitory computer readable medium, and method for managing diagnostics of computer memory. In one example, a range of contiguous addresses of a physical memory may be associated with or mapped to addresses of a virtual memory. In a further example, the range of contiguous addresses may be protected from interference from other programs. One advantage of the techniques of the present disclosure is that a memory testing program may be given exclusive access to a range of contiguous address of physical memory. Therefore, using the techniques disclosed herein, a memory testing program may safely assume that the virtual memory addresses being used are associated with physical memory and not another type of storage. Meanwhile, other programs executing in the system may still execute as normal. In yet a further example, the diagnostics performed by the memory testing program may be confined within the range of contiguous addresses in order to protect other programs from interference. The aspects, features and advantages of the present disclosure will be appreciated when considered with reference to the following description of examples and accompanying figures. The following description does not limit the application; rather, the scope of the disclosure is defined by the appended claims and equivalents.

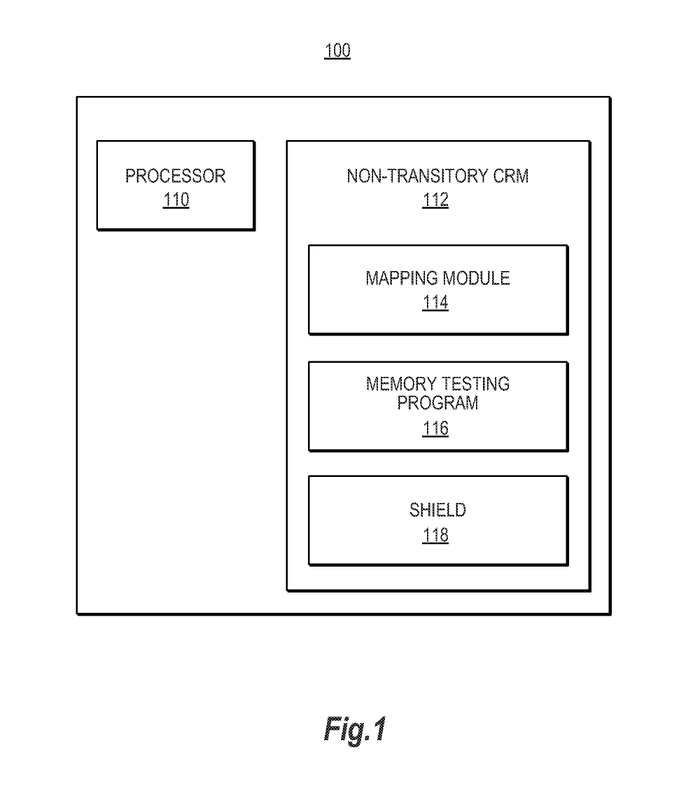

FIG. 1 presents a schematic diagram of an illustrative computer apparatus 100 for executing the techniques disclosed herein. The computer apparatus 100 may include all the components normally used in connection with a computer. For example, it may have a keyboard and mouse and/or various other types of input devices such as pen-inputs, joysticks, buttons, touch screens, etc., as well as a display, which could include, for instance, a CRT, LCD, plasma screen monitor, TV, projector, etc. Computer apparatus 100 may also comprise a network interface (not shown) to communicate with other devices over a network.

The computer apparatus 100 may also contain a processor 110, which may be any number of well known processors, such as processors from Intel® Corporation. In another example, processor 110 may be an application specific integrated circuit (“ASIC”). Non-transitory computer readable medium (“CRM”) 112 may store instructions that may be retrieved and executed by processor 110. As will be discussed in more detail below, the instructions may include a mapping module 114, a memory testing program 116, and a shield 118. In one example, non-transitory CRM 112 may be used by or in connection with any instruction execution system that can fetch or obtain the logic from non-transitory CRM 112 and execute the instructions contained therein.

Non-transitory computer readable media may comprise any one of many physical media such as, for example, electronic, magnetic, optical, electromagnetic, or semiconductor media. More specific examples of suitable non-transitory computer-readable media include, but are not limited to, a portable magnetic computer diskette such as floppy diskettes or hard drives, a read-only memory (“ROM”), an erasable programmable read-only memory, a portable compact disc or other storage devices that may be coupled to computer apparatus 100 directly or indirectly. The non-transitory CRM 112 may also include any combination of one or more of the foregoing and/or other devices as well. While only one processor and one non-transitory CRM are shown in FIG. 1, computer apparatus 100 may actually comprise additional processors and memories that may or may not be stored within the same physical housing or location.

The instructions residing in non-transitory CRM 112 may comprise any set of instructions to be executed directly (such as machine code) or indirectly (such as scripts) by processor 110. In this regard, the terms “instructions,” “scripts,” and “applications” may be used interchangeably herein. The computer executable instructions may be stored in any computer language or format, such as in object code or modules of source code. Furthermore, it is understood that the instructions may be implemented in the form of hardware, software, or a combination of hardware and software and that the examples herein are merely illustrative.

The instructions of mapping module 114 may instruct processor 110 to map a range of contiguous addresses of the physical computer memory to addresses of a virtual memory. In another example, mapping module 114 may instruct processor 110 to map an address outside the range of contiguous addresses to an address of the virtual memory for use by another program different than the memory testing program 116. Memory testing program 116 may instruct at least one processor to execute diagnostics on the contiguous addresses of the physical computer memory via a virtual memory. Shield 118 may instruct processor 110 to preclude another program, different than the memory testing program, to allocate memory within the range of contiguous addresses so as to protect the diagnostics from interference. In a further example, shield 118 may instruct processor 110 to confine the diagnostics within the range of contiguous addresses to protect other programs from interference by the memory testing program.

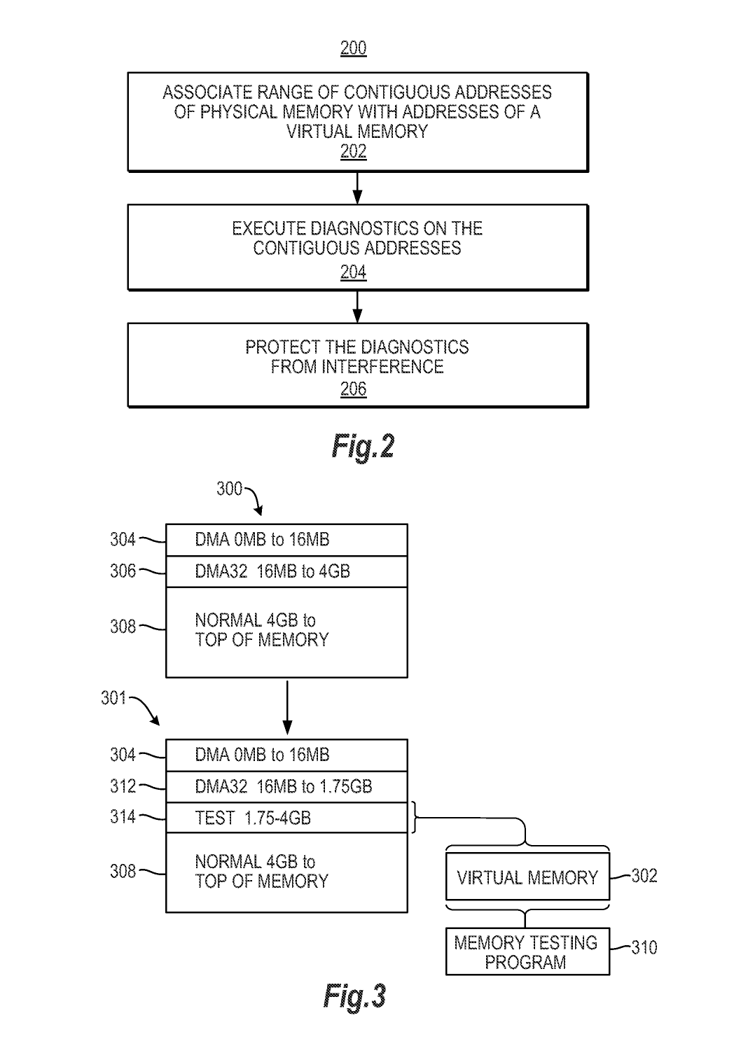

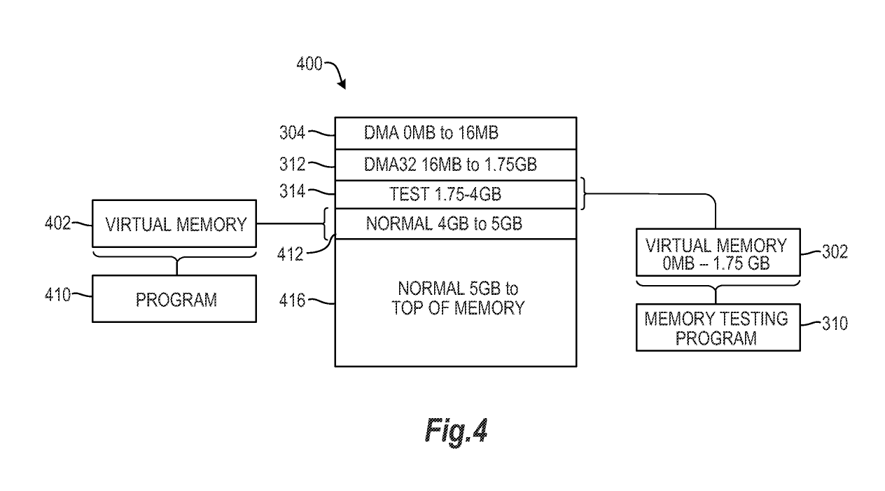

Working examples of the system, method, and non-transitory computer-readable medium are shown in FIGS. 2-4. In particular, FIG. 2 illustrates a flow diagram of an example method 200 for managing memory diagnostics. FIGS. 3-4 show a working example in accordance with the techniques disclosed herein. The actions shown in FIGS. 3-4 will be discussed below with regard to the flow diagram of FIG. 2.

As shown in block 202 of FIG. 2, a range of contiguous addresses of physical memory may be associated or mapped with addresses of a virtual memory, as shown in block 202. Referring now to FIG. 3, a before and after snapshot of a physical memory is shown. In this particular example, the physical memory is arranged in accordance with a Linux kernel zone layout.

While the examples herein make reference to the Linux operating system, it is understood that the techniques of the present disclosure may be implemented in other operating systems that utilize a virtual memory system. In a Linux system, a kernel acts as an interface between executing programs and the underlying hardware. A Linux kernel may include a physical memory management component. Once a Linux system is booted, the kernel may arrange a physical memory into a plurality of segments called zones. The types of zones may include a Direct Memory Access (“DMA”) zone or a normal zone. The DMA zone may be located in a low-end memory space and allocated for use by legacy Industry Standard Architecture (“ISA”) devices. The normal zone may be used by all other programs. Many kernel operations may only be performed in the normal zone.

In the example of FIG. 3, physical memory layout 300 may be a default zoning arrangement in which a zone 304 may be designated for 16 bit DMA requests. Requests for memory in zone 304 of physical memory layout 300 may be from 16 megabytes (“MB”) or lower. Zone 306 may be designated for 32 bit DMA requests; requests from zone 306 may be from 4 gigabytes or lower. Zone 308 may be designated for non DMA requests of 4 gigabytes and above. In one example, a Linux kernel may instruct a processor to alter the default memory arrangement. Physical memory layout 301 is one example arrangement in accordance with aspects of the present disclosure. Here, zone 306 is divided into zone 312 and test zone 314. Test zone 314 may include a contiguous range of physical memory addresses from 1.74 GB to 4 GB; each address in the contiguous range of addresses of test zone 314 may be associated with an address in virtual memory addresses 302. In this example, virtual memory addresses 302 may be generated in accordance with the Linux virtual memory system.

In one example, a change in the physical memory layout, such as the illustrative physical memory layout 301, may be achieved by altering the Linux kernel source code. In another example, the code may be compiled into the kernel based on a setting of a user defined variable in the kernel configuration file. In another aspect, a user may be able to specify a boot sequence number to indicate the zone that will be tested. This boot sequence number may be a command line argument or another variable in the kernel configuration file. In one example, when the boot sequence number is set to “0,” a first test zone may be delineated. The following example source code may be compiled into the kernel:

```
if (boot_sequence_number == 0)
{
  maxZonePfns[ZONE_DMA] = MAX_DMA_PFN;
  if (max_pfn <= ((GB_2) >> PAGE_SHIFT) )
  {
    printk(KERN_INFO ″**** MRC: init_64: memory not greater than 2G\n″);
    maxZonePfns[ZONE_DMA] = MAX_DMA_PFN;
    maxZonePfns[ZONE_DMA32] = max_pfn/3;
    maxZonePfns[ZONE_TEST] = maxZonePfns[ZONE_DMA32] + max_pfn/3;
    maxZonePfns[ZONE_NORMAL] = max_pfn;
  }
  else if ( (max_pfn > ((GB_2) >> PAGE_SHIFT))
    && (max_pfn <= (NEXT_STAGE_CUTOFF >> PAGE_SHIFT)) )
  {
    printk(KERN_INFO ″**** MRC: init_64: memory greater than 2G but less than 36G\n″);
    maxZonePfns[ZONE_DMA32] = ((DMA32_CUTOFF_1) >> PAGE_SHIFT);
    maxZonePfns[ZONE_TEST] = max_pfn;
    maxZonePfns[ZONE_NORMAL] = max_pfn;
  }
  else
  {
    printk(KERN_INFO ″**** MRC: init_64: memory greater than 36G\n″);
    maxZonePfns[ZONE_DMA32] = ((DMA32_CUTOFF_1) >> PAGE_SHIFT);
    maxZonePfns[ZONE_TEST] = NEXT_STAGE_CUTOFF >> PAGE_SHIFT;
    maxZonePfns[ZONE_NORMAL] = max_pfn;
  }
}
else
{
  if (boot_sequence_number == 1)
  {
    . . .
```

The example source code above delineates a test zone into the layout of the physical memory. Once testing of the first test zone is complete, the example boot sequence number variable may be incremented and the kernel may be rebooted. Upon reboot, a different test zone may be set aside. The incremented boot sequence number may trigger another “if” statement block (e.g., if boot_sequence_number==1, if boot_sequence_number==2, etc.). The number of test zones may vary depending on the size of the physical memory. For each “if” statement block, the code may be changed according to the area of memory being tested or the size of the test zone. The reboots and zone changes may be fully automated using a script or the like and may continue until all of the physical memory is tested.

Referring back to FIG. 2, diagnostics on the contiguous addresses may be executed, as shown in block 204. Furthermore, the diagnostics may be protected from interference, as shown in block 206. Referring back to FIG. 3, memory testing program 310 may execute diagnostics on the contiguous addresses in test zone 314 via the virtual addresses 302. Referring now to FIG. 4, program 410 may attempt to allocate memory in test zone 314; however, program 410 may be restricted or prevented from allocating memory within the range of contiguous addresses of test zone 314. Instead, addresses in zone 412 may be allocated to program 410 and mapped to virtual memory addresses 402. Additional programs may also be restricted from allocating memory within test zone 314. At the same time, the diagnostics carried out my memory testing program 310 may be confined within the range of contiguous addresses of test zone 314 such that the diagnostics do not interfere with other programs running in the system. If the physical memory is exhausted and an additional program requires memory, the additional program may be provided with virtual addresses associated with disk space or some other type of storage in lieu of allocating addresses from test zone 314. Thus, the test zone is protected even when the physical memory addresses are depleted. Once the diagnostics on test zone 314 is complete, the kernel may automatically reboot and designate a new test zone that may be protected in the same manner. As noted above, various test zones may be delineated until the entire spectrum of physical memory addresses are tested.

In one example, the following code may be inserted into any kernel source code that allocates memory for programs running in the system:

```
#if defined (CONFIG_MEMTEST_PASS1)
    if (zone_idx(zone) == ZONE_TEST)
      continue;
#elif defined (CONFIG_MEMTEST_PASS2)
  if (upper_memory_test)
          if (zone_idx(zone) == ZONE_TEST)
        continue;
      else
    if (zone_idx(zone) == ZONE_DMA)
          continue;
#endif
```

The example code above may shield a test zone indicated by the illustrative CONFIG_MEMTEST_PASS variables. For example, when testing a first test zone, the value of CONFIG_MEMTEST_PASS1 may be set to “True” or “Y” while CONFIG_MEMTEST_PASS2 may be set to “False” or “N.” When testing the second zone, the values of the two variables may switch, such that the second test zone is protected. It is understood that many more test zones may be configured and that multiple passes may be carried out (e.g., CONFIG_MEMTEST_PASS3, CONFIG_MEMTEST_PASS4 etc.).

Advantageously, the foregoing system, method, and non-transitory computer readable medium allow memory testing software to safely assume that the virtual memory addresses being used are mapped to physical memory addresses. In this regard, testing engineers may also safely rely on the test results knowing that no disk space was allocated to the testing program during the diagnostics. Furthermore, the techniques disclosed above may ensure that critical memory errors are not overlooked.

Although the disclosure herein has been described with reference to particular examples, it is to be understood that these examples are merely illustrative of the principles of the disclosure. It is therefore to be understood that numerous modifications may be made to the examples and that other arrangements may be devised without departing from the spirit and scope of the disclosure as defined by the appended claims. Furthermore, while particular processes are shown in a specific order in the appended drawings, such processes are not limited to any particular order unless such order is expressly set forth herein; rather, processes may be performed in a different order or concurrently and steps may be added or omitted.

1. A system comprising,
a physical computer memory;
a mapping module which, if executed, instructs at least one processor to map a range of contiguous addresses of the physical computer memory to addresses of a virtual memory;
a memory testing program which, if executed, instructs at least one processor to execute diagnostics on the contiguous addresses of the physical computer memory via the virtual memory; and
a shield which, if executed, instructs at least one processor to preclude another program, different than the memory testing program, to allocate memory within the range of contiguous addresses so as to protect the diagnostics from interference.

2. The system of claim 1, wherein the mapping module, if executed, further instructs at least one processor to map an address outside the range of contiguous addresses to an address in the virtual memory for use by the program different than the memory testing program.

3. The system of claim 1, wherein the shield, if executed, further instructs at least one processor to confine the diagnostics performed by the memory testing program within the range of contiguous addresses in order to protect other programs from interference.

4. The system of claim 1, wherein the virtual memory is a Linux virtual memory.

5. The system if claim 1, wherein the shield is configured in a kernel of a Linux operating system.

6. A non-transitory computer readable medium, comprising instructions therein which, if executed, instruct at least one processor to:
associate each address within a range of contiguous addresses in a physical computer memory to an address in a virtual memory;
execute diagnostics on the contiguous addresses of the physical computer memory via the virtual memory; and
prevent a program from allocating memory within the range of contiguous addresses of the physical computer memory such that the program does not interfere with the diagnostics.

7. The non-transitory computer readable medium of claim 6, wherein the instructions therein, if executed, further instruct at least one processor to map an address outside the range of contiguous addresses to another address in the virtual memory for use by the program.

8. The non-transitory computer readable medium of claim 6, wherein the instructions therein, if executed, further instruct at least one processor to confine execution of the diagnostics within the range of contiguous addresses such that the diagnostics do not interfere with another program.

9. The non-transitory computer readable medium of claim 6, wherein the virtual memory is a Linux virtual memory.

10. The non-transitory computer readable medium of claim 6, wherein the instructions to prevent the program from allocating memory within the range of contiguous addresses of the physical computer memory are in a kernel of a Linux operating system.

11. A method comprising:
associating, using at least one processor, each address in a range of contiguous addresses of a physical computer memory with an address of a virtual memory;
executing, using at least one processor, diagnostics on the contiguous addresses of the physical computer memory via the virtual memory; and
restricting, using at least one processor, other programs from allocating memory within the range of contiguous addresses of the physical computer memory so as to protect the diagnostics from interference by the other programs.

12. The method of claim 11, further comprising mapping, using at least one processor, an address in the physical computer memory to another address in the virtual memory for use by a program different than the memory testing program.

13. The method of claim 12, wherein mapping the address in the physical memory further comprises verifying, using at least one processor, that the address in the physical memory mapped to the address in the virtual memory is outside the range of contiguous addresses.

14. The method of claim 11, further comprising restricting, using at least one processor, the memory testing program from accessing addresses of the physical memory outside the range of contiguous addresses such that the memory testing program does not interfere with other programs.

15. The method of claim 11, wherein the virtual memory is a Linux virtual memory.

16. The method of claim 15, wherein restricting other programs from allocating memory within the range of contiguous addresses of the physical computer memory is initiated by a kernel of a Linux operating system.
